(19) United States
(12) Patent Application Publication
(10) Pub. No.: US 2025/0329970 A1
(43) Pub. Date: Oct. 23, 2025

(54) CONNECTION ADAPTER APPARATUS FOR SENSOR DEVICES

(71) Applicant: VERTIV CORPORATION, Westerville, OH (US)

(72) Inventors: Matthew G. Keller, Huntsville, AL (US); William R. Lazenby, Jr., Madison, AL (US); Jonathan Heath, Madison, AL (US); John David Perry, Harvest, AL (US)

(21) Appl. No.: 19/077,938

(22) Filed: Mar. 12, 2025

Related U.S. Application Data
(60) Provisional application No. 63/637,586, filed on Apr. 23, 2024.

(51) Int. Cl. H01R 31/06

(52) U.S. Cl. CPC H01R 31/06; H01R 2201/20

(57) ABSTRACT

An adapter apparatus for connecting a sensor device and a base device includes an RJ-45 connector pluggable into the base device. Among the RJ-45 contacts are a power supply contact and data contact for the base device as well as a ground contact. The adapter apparatus further includes an RJ-12 port capable of accepting an RJ-12 connector of the sensor device; among the RJ-12 contacts are a power supply contact and data contact for the sensor device as well as a ground contact. The adapter apparatus further includes a housing enclosing power supply, data, and ground wires for internally connecting the respective RJ-45 and RJ-12 power supply, data, and ground contacts.

### CROSS-REFERENCE TO RELATED APPLICATIONS

The present application claims the benefit under 35 U.S.C. § 119(e) of U.S. Provisional Patent Application Ser. No. 63/637,586 filed Apr. 23, 2024 and titled CONNECTION ADAPTER APPARATUS FOR SENSOR DEVICES. Said U.S. Provisional Patent Application 63/637,586 is incorporated herein by reference in its entirety.

### TECHNICAL FIELD

The present disclosure is directed to plug-in adapter devices for sensor equipment.

### BACKGROUND

Serial console devices and network monitoring interface cards allow rack power distribution units (PDU, rPDU) and other information technology (IT) infrastructure devices and/or applications running thereon to be accessed and managed remotely (e.g., via Ethernet and/or RS-485 networks). For example, remote monitoring and management allows troubleshooting or emergency response without necessarily requiring an engineer to physically access the managed device. Current and next-generation consoles and cards may include ports to accommodate plug-in environmental sensors for directly monitoring temperatures in critical environments, but RJ-45 environmental ports may not be compatible with RJ-12 connectors used by global standard sensor devices.

### SUMMARY

In a first aspect, an adapter apparatus for connecting a base device and a sensor device is disclosed. In embodiments, the adapter apparatus includes an RJ-45 connector pluggable into the RJ-45 port of the base device. The RJ-45 (e.g., 8-contact) contacts include power supply, data, and ground contacts for carrying power and data between the adapter and the base device. The adapter apparatus further includes an RJ-12 port capable of accepting an RJ-12 plug or connector from the sensor device. Similarly, the RJ-12 (e.g., 6-contact) contacts include power supply, data, and ground contacts for carrying power or data between the adapter and the sensor device. The adapter apparatus includes power supply wires for connecting the power supply contacts on the RJ-45 and RJ-12 ends, data wires for connecting the data contacts, and ground wires for connecting the ground contacts.

In some embodiments, the RJ-12 port includes two ground contacts, and the ground wire connects the RJ-45 ground contact to the two RJ-12 ground contacts.

In some embodiments, the sensor device is a temperature sensor.

In some embodiments, the sensor device is a pressure sensor.

In some embodiments, the sensor device is a humidity sensor.

In some embodiments, the base device is a serial console for wired or wireless monitoring of a target device.

In some embodiments, the base device is a communications card capable of physically interfacing with a target device.

In some embodiments, the RJ-45 connector is an RJ-45 plug pluggable into an RJ-45 jack of the base device.

In some embodiments, the RJ-12 port is an RJ-12 jack capable of accepting an RJ-12 plug of the sensor device.

In some embodiments, the RJ-45 power supply, ground, and data contacts include connector pins.

In some embodiments, the RJ-12 power supply, ground, and data contacts include connector pins.

In some embodiments, the RJ-12 port is enclosed within a housing, and the power supply, data, and ground wires incorporated into and enclosed by a cable connecting the housing and the RJ-45 connector.

In some embodiments, the base device is capable of downloading, e.g., from the sensor device, modular firmware, e.g., for communicating with the sensor device, via the adapter apparatus.

In some embodiments, the adapter apparatus includes read-only memory (ROM) for storage of the modular firmware.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 is a diagrammatic illustration of an adapter device according to example embodiments of the inventive concepts disclosed herein;

FIG. 2A is an illustration of an alternative implementation of the adapter device of FIG. 1;

FIG. 2B is an illustration of a connector port of the adapter device of FIG. 2A;

FIG. 2C is an illustration of a connector plug of the adapter device of FIG. 2A;

FIG. 3 is a diagrammatic illustration of internal wiring and components of the adapter device of FIGS. 1 and 2A; and

FIG. 4 is an alternative implementation of the adapter device of FIGS. 1 and 2A.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Broadly speaking, embodiments of the inventive concepts disclosed herein are directed to an adapter device allowing sensor devices equipped with RJ-12 connectors (e.g., “male” connectors (plugs) or “female” connectors (jacks, ports sockets)) to connect to and interface with serial console devices, communications cards, or any other appropriate appliance having an RJ-45 connector and/or ports compatible with an RJ-45 connector plug. The adapter device allows legacy RJ-45 capable appliances to support newer sensor devices equipped with RJ-12 connectors.

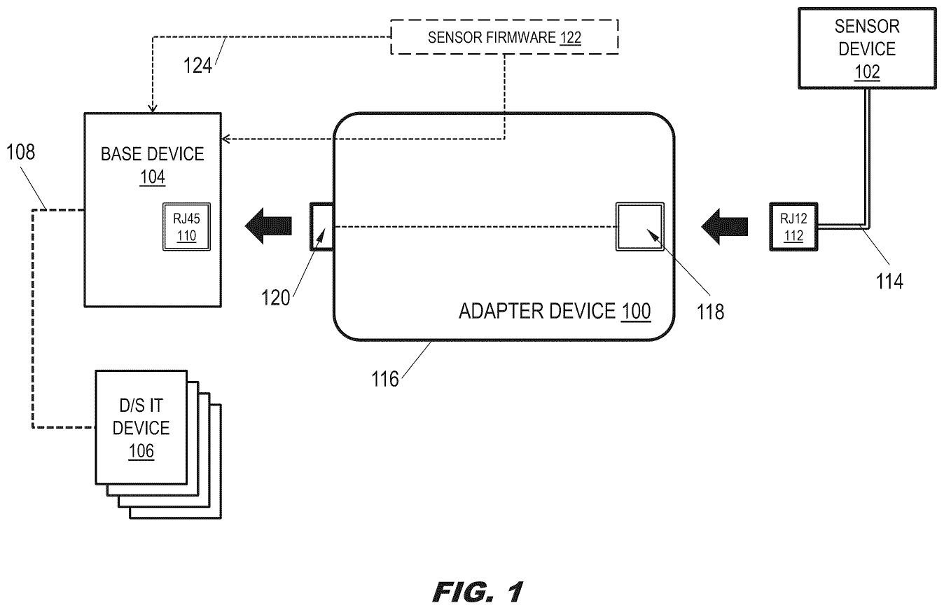

Referring to FIG. 1, an adapter device 100, sensor device 102, and base device 104 are shown.

In embodiments, the base device 104 may be a serial console device capable of remote management and/or monitoring of downstream I/T devices 106 (target devices; e.g., servers, cooling systems, other support infrastructure) via physical and/or wireless connection 108 (e.g., Ethernet, RS-486, other appropriate wired or wireless data link protocols). In embodiments, the base device 104 may include an RJ-45 compatible connector port 110 via which any RJ-45 connector plug can connect, e.g., for exchange of data and/or operating power.

In embodiments, the sensor device 102 may be a temperature sensor or any other like environmental sensor (e.g., pressure sensor, humidity sensor, etc.). For example, the sensor device 102 may include a temperature probe connected to an RJ-12 connector plug 112 by a cable 114. In embodiments, the RJ-12 connector plug 112 of the sensor device 102 may be capable of plugging into or interfacing with any RJ-12 compatible jack or socket.

In embodiments, the adapter device 100 may include a housing 116. For example, the housing 116 may include an RJ-12 compatible jack or socket 118 capable of accepting the RJ-12 connector plug 112 and an RJ-45 connector plug 120 capable of plugging into the RJ-45 compatible connector port 110. For example, the RJ-12 connector plug 112 of the sensor device 102 may plug into the adapter device 100 via the RJ-12 jack 118, and the RJ-45 connector plug 120 of the adapter device 100 may plug into the base device 104 via the RJ-45 connector port 110.

In embodiments, one or more of the RJ-12 and RJ-45 connections described above may be inverted. For example, the sensor device 102 may include an RJ-12 connector port (e.g., female connector) capable of accepting an RJ-12 connector plug, which the adapter device 100 may incorporate within the housing 116. Similarly, the base device 104 may include an RJ-45 connector plug capable of plugging into an RJ-45 compatible jack or port within the housing 116.

In embodiments, any base device 104 to which the adapter device 100 plugs into, e.g., via the RJ-45 connector plug 120 and RJ-45 connector port 110, and to which a sensor device 102 is connected, e.g., via the RJ-12 connector plug 112 and RJ-12 connector jack 118, may configure itself for communication with the sensor device (e.g., for autopopulation of temperature or environmental data and/or power exchange) by downloading modular firmware 122 compatible with the sensor device. For example, when the adapter device 100 is connected to a base device 104 via the RJ-45 connector plug 120 and to a sensor device 102 via the RJ-12 connector jack 118, the base device 104 may download modular firmware 122 from the sensor device via the adapter device. In some embodiments, the base device 104 may connect (124) physically or wirelessly to a server from which a current or compatible version of the modular firmware 122 may be downloaded.

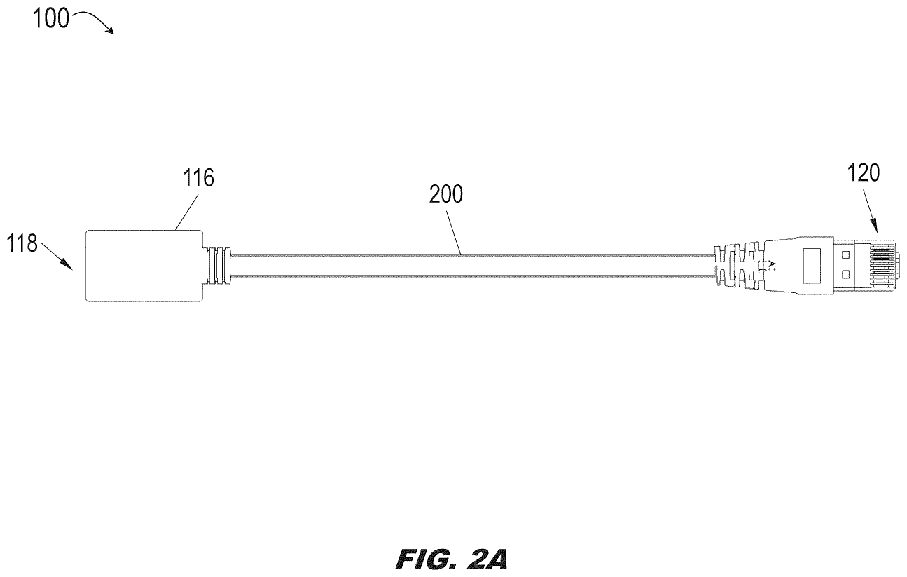

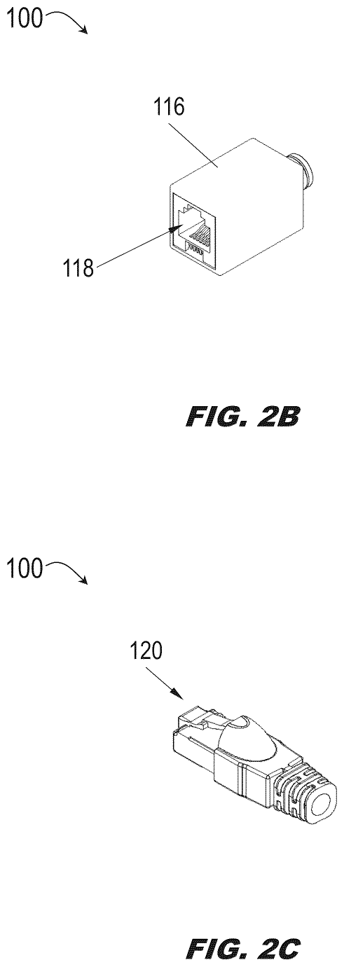

In some embodiments, both the RJ-12 connector jack 118 and RJ-45 connector plug 120 of the adapter device 100 may be fully or partially enclosed by the housing 116. In other embodiments, referring in particular to FIGS. 2A through 2C, the RJ-45 connector plug 120 may be coupled to the housing 116 via a cable 200200 (e.g., an RJ-45 compatible cable). In some embodiments, the housing 116 enclosing the RJ-12 connector jack 118 (or wherein the connector jack is disposed) may include a cable 200, or a portion thereof.

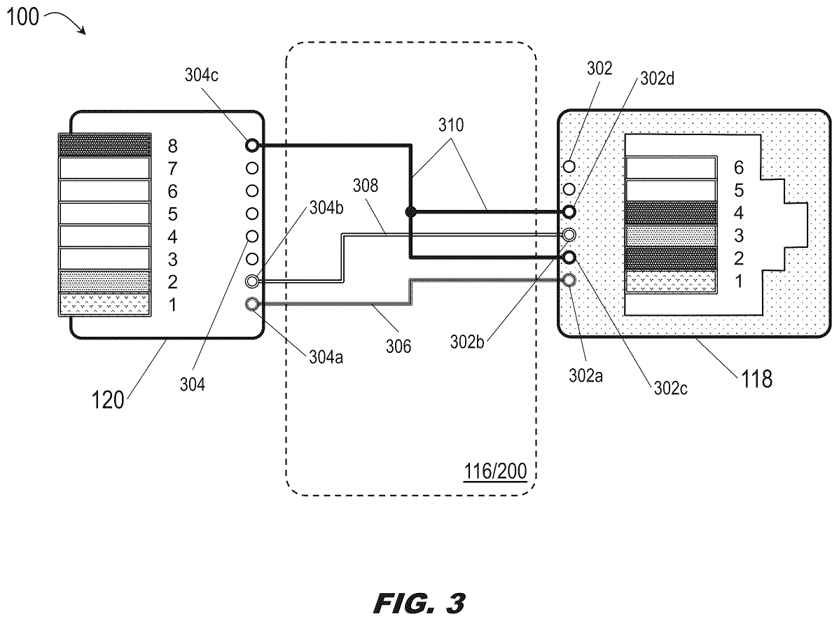

Referring to FIG. 3, the adapter device 100 is shown.

In embodiments, the RJ-12 connector jack 118 may be a 6-pin jack comprising a set of connector pins 302 (contacts). For example, each of the connector pins 302 may connect to a corresponding connector pin (contact) of a 6-pin RJ-12 connector plug (112, FIG. 1) of the sensor device (102, FIG. 1). Similarly, the RJ-45 connector plug 120 may be an 8-pin plug comprising a set of eight connector pins 304 (contacts), each of the connector pins connectible to a corresponding connector pin (contact) of the 8-pin RJ-45 compatible connector port (110, FIG. 1) of the base device (104, FIG. 1). In embodiments, the connector pins 302, 304 may include any appropriate physical contacts capable of interfacing the RJ-12 connector jack 118 and RJ-45 connector plug 120 with other RJ-12 and/or RJ-45 compatible devices.

In embodiments, the adapter device 100 may include internal wiring (e.g., disposed within the housing 116 and/or enclosed within the cable 200) configured for communicatively connecting the connector pins 302 with their corresponding connector pins 304, thereby enabling data and/or power exchange between the sensor device 102 and the base device 104 (e.g., enabled by deployment of the modular sensor firmware (122, FIG. 1) to the base device). For example, the RJ-12 connector jack 118 may include one or more power supply pins 302a capable of carrying operating power (e.g., 5 V) to or from the sensor device 102; one or more data pins 302b capable of data transfer to or from the sensor device; and one or more ground pins 302c capable of providing a ground connection to the sensor device. In some embodiments, the RJ-12 connector jack 118 may include two ground pins 302c, 302d. Further, each of the power supply pins 302a, data pins 302b, and ground pins 302c, 302d may be compatible and connectible with counterpart contacts (e.g., connector pins) within the RJ-12 connector plug (112, FIG. 1) of the sensor device.

In embodiments, the RJ-45 connector plug 120 may include one or more power supply pins 304a, one or more data pins 304b, and one or more ground pins 304c similarly compatible with and connectible to their counterpart connector pins within the RJ-45 connector port (110, FIG. 1) of the base device 104. Similarly, the power supply pins 304a, data pins 304b, and ground pins 304c may carry operating power, data transfer, and/or ground connection between the base device 104 and the adapter device 100.

In embodiments, the adapter device 100 may include one or more power supply wires 306 connecting the power supply pins 302a, 304a; one or more data wires 308 connecting the data pins 302b, 304b; and one or more ground wires 310 connecting the ground pins 302c, 302d, 304c.

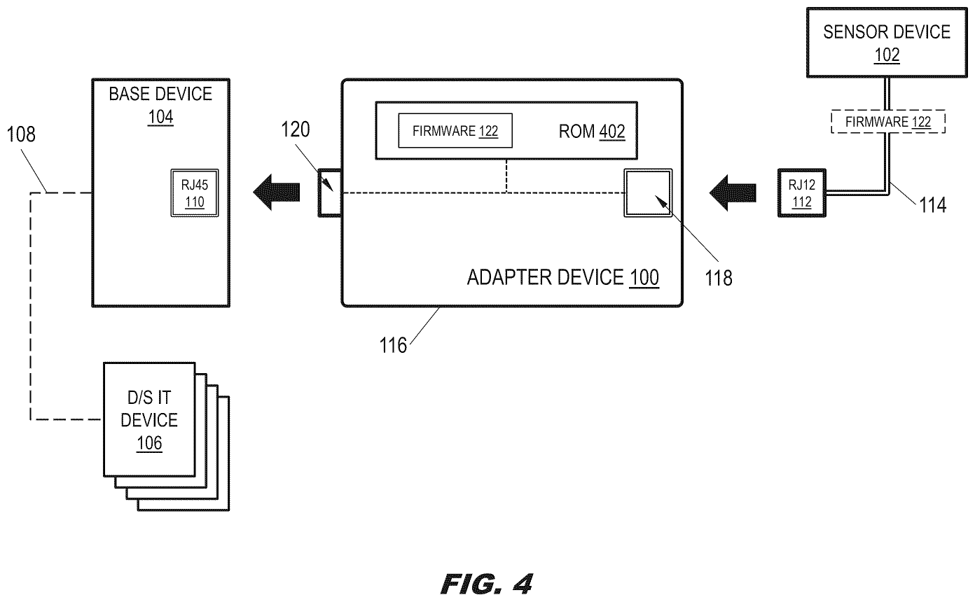

Referring now to FIG. 4, in some embodiments the base device 104 may download modular sensor firmware 122 via the adapter device 100, e.g. via the RJ-45 connector plug 120 and connector port 110 thereof. For example, the modular sensor firmware 122 may enable the base device 104 and the sensor device 102 to communicate with each other. In some embodiments, the adapter device 100 may include onboard read-only memory 402 (ROM) or like data storage configured to store the modular sensor firmware 122.

### CONCLUSION

It is contemplated that embodiments of the inventive concepts disclosed herein may have numerous advantages. For example, base devices using RJ-45 ports will be able to communicate with legacy sensor devices, enabling the continued use of said sensor devices without the need for new board development. Further, modular firmware can evolve to ensure that next-generation devices with RJ-45 ports will also be compatible with legacy sensors.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be implemented (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be implemented, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

We claim:

1. An adapter apparatus, comprising:
a first RJ-45 connector compatible with a second RJ-45 connector of a base device, the first RJ-45 connector comprising a plurality of eight first contacts including at least one of:
a first power supply contact configured to carry a power supply between the adapter apparatus and the base device;
a first ground contact;
and
a first data contact configured to carry data between the adapter apparatus and the base device;
a first RJ-12 connector configured to accept a second RJ-12 connector of a sensor device, the first RJ-12 connector comprising a plurality of six second contacts including at least one of:
a second power supply contact configured to carry the power supply between the adapter apparatus and the sensor device;
a second ground contact;
and
a second data contact configured to carry data between the adapter apparatus and the sensor device;
at least one power supply wire connecting the at least one first and second power supply contacts;
at least one ground wire connecting the at least one first and second ground contacts;
and
at least one data wire connecting the at least one first and second data contacts.

2. The adapter apparatus of claim 1, wherein:
the first RJ-12 connector includes two second ground contacts;
and
wherein the at least one ground wire connects the first ground contact and the two second ground contacts.

3. The adapter apparatus of claim 1, wherein the sensor device is a temperature sensor.

4. The adapter apparatus of claim 1, wherein the sensor device is a pressure sensor.

5. The adapter apparatus of claim 1, wherein the sensor device is a humidity sensor.

6. The adapter apparatus of claim 1, wherein the base device is a serial console device configured for monitoring a target device via at least one of a physical connection or a wireless connection.

7. The adapter apparatus of claim 1, wherein the base device is a communications card, the communications card configured for physical interfacing with a target device.

8. The adapter apparatus of claim 1, wherein:
the first RJ-45 connector is an RJ-45 plug;
and
the second RJ-45 connector is an RJ-45 jack.

9. The adapter apparatus of claim 1, wherein:
the first RJ-12 connector is an RJ-12 jack;
and
the second RJ-12 connector is an RJ-12 plug.

10. The adapter apparatus of claim 1, wherein:
the first power supply contact is a first power supply connector pin;
the first ground contact is a first ground connector pin;
and
the first data contact is a first data connector pin.

11. The adapter apparatus of claim 1, wherein:
the second power supply contact is a second power supply connector pin;
the second ground contact is a second ground connector pin;
and
the second data contact is a second data connector pin.

12. The adapter apparatus of claim 1, wherein:
the first RJ-12 connector is enclosed within a housing;
and
wherein the at least one power supply wire, the at least one data wire, and the at least one ground wire are at least partially enclosed within a cable connecting the housing and the first RJ-45 connector.

13. The adapter apparatus of claim 1, wherein:
the base device is capable of downloading firmware via the adapter apparatus;
and
the firmware is configured for communicatively connecting the base device to the sensor device.

14. The adapter apparatus of claim 13, further comprising:
a read-only memory (ROM) configured for storage of the firmware.
